(19) United States
(12) Patent Application Publication
(10) Pub. No.: US 2010/0205649 A1
(43) Pub. Date: Aug. 12, 2010

(54) CREDENTIAL GATHERING WITH DEFERRED INSTANTIATION

(75) Inventors: Moritz Y. Becker, Cambridge (GB); Jason F. Mackay, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/367,502

(22) Filed: Feb. 6, 2009

(51) Int. Cl. H04L 9/32; G06F 17/00

(52) U.S. Cl. 726/1; 726/2; 726/5

(57) ABSTRACT

Credentials may be gathered to support an access request. In one example, a template describes the credentials to be gathered. A set of credential providers may be consulted, in a particular sequence, to provide the credentials. Credentials may contain variables, and each credential provider may impose its own constraints on the values to be assigned to the variables. Instantiation of the variables may be deferred to a downstream credential provider, thereby allowing each credential provider to specify its constraints on the variables before specific values for the variables are chosen. In one example, an instantiation fact (or “inst fact”) is used to represent the deferred instantiation. A provider may use an inst fact to make its credentials conditional on the instantiation of the variables that the credential contains, where some downstream provider may attempt to instantiate the variables to specific values.

### BACKGROUND

A resource, such as a file, a database, a service, a hardware component, etc., may be protected by a resource guard. The guard gates access to the resource, and implements a policy that determines when access to the resource is to be granted. When a requester seeks access to the resource, the requester presents one or more credentials to the guard. If the credentials demonstrate the requestor's right to access the resource, the guard permits access. Otherwise, the guard denies access.

Some policies and credential schemes are simple. For example, a policy might state, “Whoever presents the correct password gains access.” In this example, a password is the credential, and whoever presents the correct password gains access. However, modern authorization systems can implement more complicated policies, in which obtaining access may involve presenting credentials issued by several different parties. The various credentials involved in obtaining access, and the parties that issue those credentials, may relate to each other in complex ways.

In one example, policies are expressed as logical assertions. In order to gain access to a resource in such a system, the guard has to assert that the principal may access the resource. E.g., in order to permit a principal named “Joe” to read a file named “foo”, the guard would have to make the assertion “Guard says Joe can read foo.” (An assertion is a combination of a fact and a principal who says the fact. In this example, “Joe can read foo” is a “fact”, and preceding this fact by the phrase “Guard says” means that the principal named “Guard” has asserted the fact to be true.) The guard may have a policy that specifies the circumstances under which the guard is willing to make that assertion, and the policy may involve complex delegations to other principles. For example, the guard's policy may say: “Guard says x can read foo, if fact₁, . . . , factₙ are true,” where x is a variable that represents the name of a principal whom the guard is willing to say may read foo. The policy may delegate to other principals the right to determine whether fact₁ through factₙ are true—that is, the guard may delegate to other principals the right to assert (or not to assert) those facts. So, the guard may be willing to say “Joe can read foo” as long as some principal (P₁) says that fact₁ is true, some other principal (P₂) says fact₂ is true, etc. In some cases, principals P₁, P₂, . . . may further delegate the right to assert fact₁, fact₂, . . . to principals who are further downstream. In this case, the credential that support access are the assertions that are made by the principals to whom the guard has delegated fact₁ through factₙ, or assertions made by principals to whom those facts have been re-delegated. So, in short, the credentials may involve action by various different parties, having complex relationships to each other.

One issue that arises in obtaining the credentials is that assertions may have variables, but each variable has to be ground to an actual value before the assertion can be presented to the guard to support an access request. That is, if fact₁ through factₙ are true, then the guard may be willing to say “x can read foo” for any value of x. But x is an abstraction, and as a practical matter, when an access request is made the guard does not grant access to the abstraction that x represents, but rather grants access to a specific named principal (or, at least, a named collection of principals). Thus, while it makes sense to allow the guard to say “x can read foo” in order to express the breadth of principals to whom the guard is willing to allow access, at some point x has to be ground to an actual value (e.g., “Joe”), thereby giving a specific principal the right to read foo.

When variables are introduced into facts, they may be constrained in some manner. For example, the guard may not be willing to say “x can read foo” for any value of x, but only for those principals whose name begins with J. Thus, a constraint on x might be that x be a character string that begins with J. fact₁ through factₙ might have variables with their own constraints, and even the delegations that the guard makes to P₁, P₂, etc., which allow those principals to assert the facts, might introduce variables. The variables might be interrelated in various complex ways.

In theory, any principal who provides a credential could ground the variable to a value at the time the credential is provided. However, if one principal grounds a variable before other principals have been consulted, the grounding of the variable at that early point imposes a constraint on that variable that might conflict with the assertions that principals who are consulted subsequently are willing to make.

### SUMMARY

The credentials to support an access query may be described in a template, and the template may be passed through a chain of credential providers in order to obtain the credentials to satisfy the template. Each of the credential providers in the chain is consulted, in sequence. Each provider supplies whatever credentials it can toward the goal of satisfying the template, and then passes the template to the next provider in the chain. In one example, instantiation of variables may be deferred to the last provider in the chain.

Credentials may take the form of a principal's assertion of a fact. An assertion has a concluding fact and zero or more conditional facts. The concluding and conditional facts may involve variables, and there may be constraints on the values that can be assigned to the variables. Thus, a provider, P, may make an assertion of the form “P says Joe can read foo from t₁ to t₂, if Q gives consent from t₁ to t₂.” In this example, “Joe can read foo from t₁ to t₂” is a concluding fact, “Q gives consent from t₁ to t₂” is a conditional fact, and t₁ and t₂ are variables representing the start and end times that delimit the period for which Joe's access to foo is permitted. P may be willing to allow Joe to read foo for a limited amount of time, e.g., thirty days, and thus imposes a constraint on the values of these variables, e.g., t₂−t₁≦30 days. When P provides this credential, he could instantiate (or “assign”) t₁ and t₂ to specific values that satisfy the constraint (e.g., t₁=Jul. 1, 2009 and t₂=Jul. 30, 2009), but this early assignment of values to the variables may bind these variables to values that are inconsistent with the credentials that providers further down the chain would be willing to issue. For example, Q (who might be the owner of file foo) might only be willing to give consent for fifteen days, and thus might impose the constraint t₂−t₁≦15 days. There are values of t₁ and t₂ that would satisfy both constraints (e.g., t₁=Jul. 1, 2009 and t₂=Jul. 15, 2009), but if P chooses values for t₁ and t₂ before Q has been asked to contribute its credentials, then Q may be unable to issue a credential because the values chosen for t₁ and t₂ do not satisfy Q's constraint.

Thus, as credential providers are consulted in sequence to provide their credentials, instantiation of variables may be deferred to the last provider in the chain. So, instead of assigning specific values to t₁ and t₂, P may add, to its assertion, the conditional facts of the form “if the next provider instantiates t₁ and t₂”. Then, before passing this credential to the next credential provider in the chain, P delegates to that next provider the right to instantiate t₁ and t₂. If the next provider finds that there are additional providers to be consulted in the chain, then that provider may re-delegate instantiation of t₁ and t₂ to the next provider, and so on. Each provider may contribute constraints to t₁ and t₂ so, by the time the last provider in the chain is reached, t₁ and t₂ may be instantiated to values that satisfy all of the constraints that have been collected through the chain. If the constraints are such that t₁ and t₂ cannot be assigned any values that satisfy all of the constraints, then satisfaction of the template fails.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which a template may be used to gather credentials.

FIGS. 2A and 2B are, collectively, a flow diagram of an example process that may be performed by a credential provider.

FIGS. 3A and 3B are, collectively, a flow diagram of an example process that may be performed by a terminal credential provider in a chain of credential providers.

FIG. 4 is a block diagram of an example medical records access scenario.

FIG. 5 is a block diagram of example components that may be used in connection with implementations of the subject matter described herein.

### DETAILED DESCRIPTION

In systems that control the use of resources, a policy determines the circumstances under which access to a resource is granted. A resource guard implements the policy, so when access to the resource is requested, the guard determines whether access to the resource is permitted under the policy.

The policy that the guard implements may impose various conditions on access. One kind of condition is that appropriate credentials be presented before access is permitted. A simple example of a credential is a password. If the guard makes access to the resource conditional on the requestor of the resource entering the correct password, then the password is a credential. However, credentials may be more complex that a simple password. Some systems allow policies to be expressed in rich logic languages, such as the Security Policy Assertion Language (SecPAL). Rich languages such as SecPAL allow complex access policies to be expressed, which allows these languages to accommodate a wide variety of access scenarios. A price of this versatility is that the set of credentials that is used to gain access may be complicated. Obtaining the credential may involve several different parties, and it may not even be clear to a person seeking access what kind of credentials the policy calls for.

One way to identify a set of credentials that satisfy the access policy is to use abduction. In one model of evaluating access requests, a principal p may read a resource r if the resource guard g says so. So, demonstrating that p's request for the resource is allowable amounts to proving that a statement like “g says p can read r” is true under some set of logical rules. Credentials are premises from which the statement is deduced, and the guard's policy defines the rules of deduction. If the conclusion “g says p can read r” can be deduced from the credentials provided under the applicable policy, then the guard allows r to read p. For example, the policy might say that the guard delegates to “Bob” the right to let anyone read r. E.g., the policy might contain the statement “g says Bob can say x can read r, where x matches/.+/”. (/.+/denotes the regular expression that matches any string of non-zero length.) The “can say” verb represents delegation. So, if g says that Bob can say something, and if Bob says that thing, then g will say it too. So, under this policy, the statement “Bob says p can read r” is a premise from which the conclusion “g says p can read r” can be deduced. Thus, the statement “Bob says p can read r” is an example of a credential that p could present to guard g in order to gain access to r.

Abduction is like deduction in reverse. If one starts with the above conclusion, then abduction is the process of inferring facts that, if true, would lead to that conclusion. If one starts with the conclusion “g says p can read r” and wants to know what premise(s) would lead to this conclusion, one can infer these premises using abduction. One may view a query as a statement to be proved, and credentials as the premises that prove the query, so access is allowed if a complete proof of the query is presented. If one views queries and credentials in this way, then abduction can be used to identify the kinds of credential(s) that would allow access. There are various ways to perform abduction. An example abduction process, and its use to abduce credentials to support an access request, is described in U.S. patent application Ser. No. 11/962,746, which is incorporated herein by reference.

Although abduction may be used to identify the credentials that would support access, those credentials may or may not exist. In the above example, the statement “Bob says p can read r” is a credential from which the access condition “g says p can read r” can be deduced. An abduction process might be used to determine that this credential would support p's access to r, but whether access will actually be granted depends on whether Bob has issued (or is willing to issue) this credential. Thus, abduction can identify the credentials that, if extant, would allow access, but obtaining those credentials is a separate matter.

The subject matter described herein may be used to obtain credentials to support an access request, and is able to do so with relatively few pre-requisites. In general, if there is a set of providers to be consulted, the protocol may be used as long as each provider knows whether it is the last provider in the chain and, if not, knows who the next provider in the chain is and can send a message to that provider. This means that it is possible to consult a set of providers for credentials, even if the providers are not all able to communicate with each other, or are not available to be consulted at the same time, or even if some of the providers are not aware of each other.

The subject matter herein uses a template that describes the credentials that are sought in order to satisfy an access request. The template may be generated by abduction, but could also be generated in other ways (e.g., a person could create the template by hand). The template is passed through a series of credential providers, where each provider attempts to provide some or all of the credentials that satisfy the template. Each provider identifies the next provider in the series, and each provider knows whether it is the last one in the series. If the template has been satisfied by the time it reaches the last provider in the series, then the credentials that allow access may be provided to the entity that seeks access. Otherwise, the process reports failure. In order to increase the chance that the template will be satisfied, the process may use a late binding mechanism for variables. Facts are often expressed in terms of variables, and the late binding mechanism may delay instantiation of variables until the template reaches the last provider, thereby providing flexibility as to the values to which the variables will be ground. Late binding may be implemented though the use of an “instantiation fact” (or “inst fact”). Inst facts and their use are described below.

U.S. patent application Ser. No. 11/962,761, which is incorporated herein by reference, describes a process by which one may use a template (generated by abduction, or otherwise) to obtain the credentials that allow a principal to gain access to a resource. That process may consult several credential providers to obtain the credentials, but variables in the template may be instantiated relatively early in the credential-gathering process. This process may allow those entities that are consulted early in the credential-gathering process to bind variables in ways that are inconsistent with the credentials that later-consulted entities are able to provide. Thus, some templates that theoretically could be satisfied by credentials that exist (or that could be issued) will not end up being satisfied because of variables' being bound too early in the process. The late binding technique described herein addresses this issue.

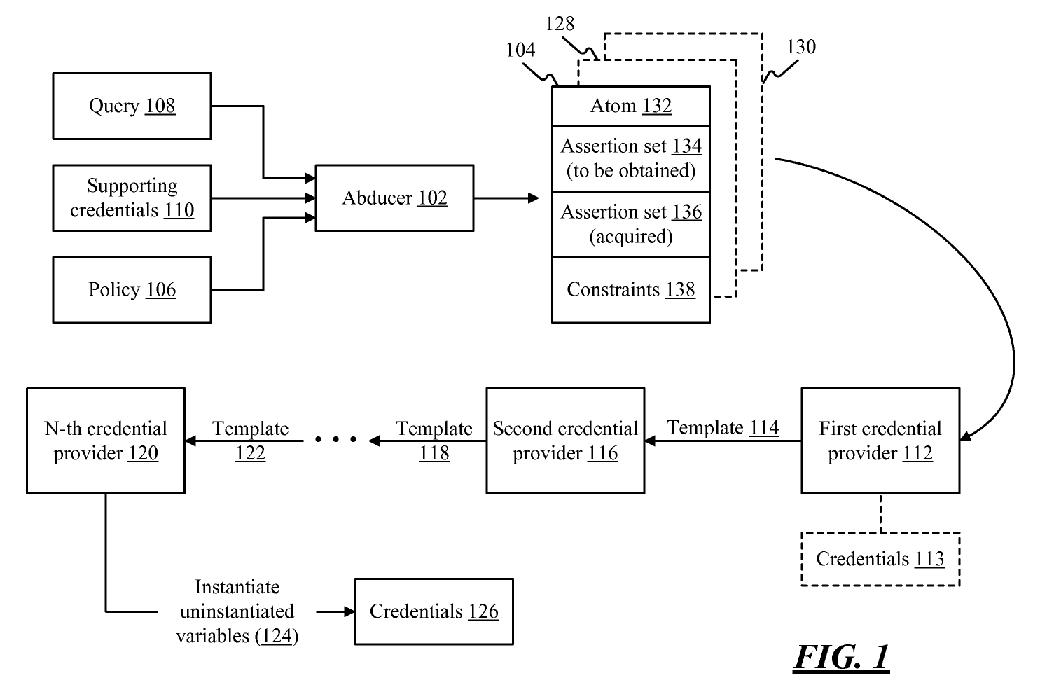

Turning now to the drawings, FIG. 1 shows an example system in which a template may be used to gather credentials from various entities, in order to facilitate access to a resource. Abducer 102 generates template 104 based on policy 106, query 108, and supporting credentials 110. Query 108 represents a statement that, if true, would cause a resource guard to permit a principal to access a resource. Template 104, which is the output of abducer 102, describes a set of assertions which—if presented to the guard in the form of credentials—would cause the guard to conclude that query 108 is true under policy 106. As discussed below, abducer 102 may actually produce a set of templates, each representing a possible solution to the query. The template (or template set) is passed through a series of one or more credential providers, which attempt to provide the credentials described in the template. The process of gathering credentials either succeeds (if the providers are able to provide the credentials described by the template), or fails (if the providers are unable to provide those credentials). Thus, template 104 is passed to the first credential provider 112, which attempts to provide some credentials 113 that satisfy the template. Credential provider 112 then creates a modified version of template 104 (which is labeled as template 114), which indicates which credentials remain to be provided after credential provider 112 has provided the credentials that it is able to provide. The second credential provider 116 then receives template 114, attempts to provide additional credentials, and produces template 118 which indicates which credentials have been provided up to that point, and which ones remain to be obtained. This process continues through a series of credential providers, until the last (nth) credential provider 120 receives template 122. Credential provider 120 adds any remaining credentials that have not yet been provided, including the credentials to instantiate any uninstantiated variables (at 124). (Variables, their instantiation, and the reasons for which a template might contain uninstantiated variables, are described below.) If the process succeeds, the result of the process is a set of credentials 126 that may be presented to a resource guard to gain access to the resource. The credential providers 112, 116, and 116 may be physically separate components (e.g., separate machines that function as credential servers) that are connected to each other in some manner (e.g., through a network), although they could take any form (e.g., separate server programs running on one machine).

To simplify illustration, FIG. 1 shows an example in which abducer 102 produces a single template, and in which a single template is passed from credential provided to credential provider. However, abducer 102 may produce a set of one or more templates representing alternative solutions to a query. Moreover, each credential provider may evaluate the different templates in the set one-by-one, and the credential provider may be able to contribute credentials representing alternative solutions to a given template in the set. In such a case, the credential provider may add templates to the output set, representing that provider's alternative solutions to each of the templates in the set. The use of sets of templates, and the possibility that each credential provider could add templates to the set that represent different solution branches, is described in greater detail in connection with the algorithms of Tables 1 and 2 below. For the purpose of illustration FIG. 1 shows a single template, although it will be understood that a set comprising any number of templates could be used.

The following is a description of the components in FIG. 1 in greater detail. Policy 106 is a set of rules under which a resource guard determines whether to permit access to a resource. The resource in question may be a file, a database, a hardware component, a service, or anything else to which access may be granted or denied. Although the resource could be any kind of resource, the resource may, in one example, be a physical resource, and the guard's gating of access to the resource may involve physical action. E.g., if the resource is a hardware component such a disk drive, the guard may open or block physical pathways to the disk drive, and or may initiate mechanical action (or other tangible action) to allow or prevent use of the disk drive. The resource guard may be hardware and/or software that determines whether a principal may gain access to the resource. (The principal may be a person, but may also be any type of non-person entity.) Policy 106 may be expressed as rules of logic. Logic languages such as SecPAL or Datalog may be used to express these rules, although they could be expressed in any form. The logic examples herein make use of certain concepts and terminology, so before continuing with a description of FIG. 1, certain logic concepts and terms will now be described.

Policies and credentials are expressed as assertions. An assertion is a statement of the form “Entity says fact, if fact-1, . . . , fact-n, where c.” The fact before the “if” clause is referred to as the “concluding fact”, and fact-1 through fact-n in the “if” clause are referred to as “conditional facts.” In the “where” clause, c is a constraint. The concluding fact is a fact that entity asserts is true. If one or more concluding facts are present, then the entity asserts “fact” as long as the concluding facts are true. Facts may include variables, and c expresses constraints on the values of those variables. For example, consider the assertion “Joe says x can read y, if x is an administrator, where y matches /sys.*/.” In this assertion, x and y are variables representing an entity name and a file name, respectively. Also, “x can read y” is a concluding fact, and “x is an administrator” is a conditional fact. Joe is a principal. Joe asserts that the concluding fact “x can read y” is true, as long as the conditional fact “x is an administrator” is also true. “y matches /sys.*/” is a constraint on the value of variable y. In other words, the assertion is only valid for values of y that match the regular expression /sys.*/—i.e., filenames that begin with the letters “sys”. (The “.*” in the regular expression matches any sequence of zero or more characters.) Conditional facts (the “if” clause) and constraints (the “where” clause) are both optional in an assertion. An assertion without no “if” clause and no “where” clause is an “atomic assertion.”

Access to a resource is permitted if the guard says so. A guard's policy (such as policy 106) may expressly grant a principal the right to access a resource—e.g., the policy might contain, as a rule, the assertion: “Guard says Alice can read foo” (where “foo” is the name of a file). However, the policy may involve (and often does involve) more complex conditions on access, some of which delegate decisions to other entities. For example, the policy might contain the rule: “Guard says x can read y, if x is a doctor and y is a medical record.” So, if Alice is a doctor and foo is a medical record, then this rule means that Guard will say that Alice can read foo.

The policy might delegate to other entities the right to say who is a doctor and which files are medical records. Delegation may be made with a “can say” verb. So, the policy might contain the rules:
Guard says x can read y, if x is a doctor and y is a medical record
Guard says State-Medical-Board can say x is a doctor
Guard says Hospital can say y is a medical record.
   In this example, State-Medical-Board and Hospital are delegates of the guard's authority. An aspect of this type of delegation is that, if an entity's delegate asserts a fact, then the delegating entity itself asserts the fact. Thus, if State-Medical-Board says that Alice is a doctor, then Guard says that Alice is a doctor. If Hospital says that foo is a medical record, then Guard says so too. Assuming that State-Medical-Board and Hospital have made these assertions, the conditions that Guard imposes on saying that Alice can read foo are met, so Guard will say that Alice can read foo. As a matter of implementation, an assertion like “State-Medical-Board says Alice is a doctor” or “Hospital says foo is a medical record” is typically signed (digitally) by it's asserter, and packaged as a certificate. Thus, one who seeks access may present the certificate to the guard as a credential.

There are two versions of “can say” delegations, denoted as “can say₀” and “can says”. “Can say_{∞}” means that the delegate can further delegate its authority to other delegates, while “can say₀” means that the delegate cannot further delegate its authority. If State-Medical-Board receives a “can say_{∞}” delegation, then State-Medical-Board can delegate to other entities the power to say that someone is a doctor. In that case, if State-Medical-Board makes a further delegation and a downstream recipient of that delegation says that Alice is a doctor, then Guard will honor Alice's status as a doctor. But if State-Medical-Board receives a “can say₀” delegation, then State-Medical-Board cannot delegate to other entities the power to say that someone is a doctor, and Guard will only honor Alice's status as a doctor if State-Medical-Board says so itself.

Returning now to the discussion of FIG. 1, query 108 is a statement that, if true under policy 106, allows a certain access request to proceed. For example, if Alice requests access to the file “foo”, then—under the example policy stated above—the assertion that would allow that request to proceed is “Guard says Alice can read foo”. So, this assertion is an example of a query 108.

Policy 106 and query 108 may both be provided as input to abducer 102. Abducer 102 considers query 108 and policy 106 and determines what assertions would cause query 108 to be true under policy 106. Abducer 102 might determine that that query 108 cannot be true under the policy, in which case abducer 102 indicates that the abduction has failed. Additionally, abducer 102 may determine that supporting credentials 110 already satisfy query 108, in which case abducer 102 might notify the user that submitted the query for abduction, and might indicate to the user (e.g., in the form of a proof graph) how the credentials provided (or some subset thereof) prove query 102. However, assuming that abducer 102 can find some set of assertions that, if made, would cause query 108 to be true under policy 106, and assuming that the query is not already deducible from the supporting assertions, abducer 102 produces a template 104 (which may be part of a template set), which describes those assertions.

Abducer 102 may also receive as input a set of one or more supporting credentials 110, which are credentials that abducer 102 may assume will be provided. In the example above, (1) “State-Medical-Board says Alice is a doctor” and (2) “Hospital says foo is a medical record” are assertions that would cause the query “Guard says Alice can read foo” to be true. Suppose that Alice is the one making the request, and she has a certificate from State-Medical-Board containing assertion (1). This certificate is a credential, and Alice is able to provide this credential to the resource guard when requesting access to a file. Since this credential is available, abducer 102 can assume it exists without having to infer it from the policy. So, Alice provides this credential as one of the supporting credentials 110. Abducer 102 may use supporting credentials 110 to guide it in the types of solutions to query 108 to look for. E.g., abducer 102 may explicitly look for solutions that make use of supporting credentials 110. Additionally, the output of abducer 102—i.e., template 104—may reflect that supporting credentials 110 have already been acquired, so that they do not have to be obtained from credential providers 112, 116, and 120 (or from other credential providers in the chain). If there are various different solutions to the same query, abducer can produce additional templates (e.g., templates 128 and 130), which represent different assertions that would lead to the truth of query 108. Those templates may be providers to the credential providers along with template 104 (e.g., as part of a template set), and each credential provider may attempt to satisfy all of the different templates.

Template 104 contains a description of the assertions that, if made, would cause query 108 to be true. At this point, it is noted that the abduction process performed by abducer 102 is one way to produce template 104, but template 104 could be produced in other ways. For example, template 104 could be created by a person, without using abducer 102.

Template 104 may contain atom 132, a set 134 of assertions to be obtained, a set 136 of assertions that have been acquired, and constraints 138. Atom 132 is an atomic assertion that represents the query. Set 134 contains assertions that are to be obtained by consulting credential providers. Set 136 contains assertions that are part of the proof of the query, but that do not have to be obtained from credential providers. For example, supporting credentials 110 may contain assertions that are already available and do not have to be obtained, so set 136 may contain the assertions from supporting credentials 110. But also, the contents of the template may change as the template is passed from provider to provider. Credential provider 112 outputs template 114, which follows the same basic format as template 104 and thus includes its own instance of set 136. Credential provider 112 may contribute some credentials to the template, and thus the instance of set 136 that appears in template 114 includes not only the supporting credentials 110 that may have been provided as input to the abduction process, but also whatever credentials have been provided by credential provider 112.

Constraints 138 are one or more constraints on the values of variables in the assertions. As described above, an assertion might contain a “where” clause that constrains a variable in that assertion—e.g., “Guard says x can read y, where y matches /sys.*/”. In this case, “y matches /sys.*/” is a constraint on the values that may be assigned to y, or to any variable that is substituted for y as part of a substitution. Constraints 138 are all of the assertions that apply to variables in the assertions in sets 134 and 136. Constraints 138 may be part of the original template 104 (e.g., abducer 102 may generate constraints as part of template 104). Or, constraints 138 may be added as the template is passed from credential provider to credential provider. For example, the assertions to be obtained in set 134 might contain an assertion of the form “Joe says x can read foo” where x, in this example, is a variable that stands for the name of a principal. In other words, an assertion of this form—if made by Joe—would support the truth of some query. Joe is a credential provider, and, when Joe receives the template, he might look at the template and determine that he is willing to say that users whose names begin with the string “Admin” can read foo, but that other users cannot. The assertion contained in set 134 does not impose any limitation on the values of x, but Joe might want to impose one. Joe could certainly issue a credential that grounds x to a specific value—e.g., “Joe says AdminBob can read foo”—but this credential would force subsequent credential providers to use the value to which x is ground. If Joe is not the first credential provider to which the template is passed, then grounding x at this early stage denies subsequent credential providers the chance to assign a different value to x, where the different value might be more appropriate in the context of the overall set of assertions that are to be satisfied. Thus, Joe may issue a credential that says, in effect, “Joe says x can read foo, where x matches /Admin.*/”. In this case, “x matches /Admin.*/” is a constraint that is added to the template.” In this way, a downstream credential provider can choose the actual value of x, subject to the constraint imposed by Joe.

A problem with issuing this type of credential is that it specifies the constraints on what values x may acquire, but does not actually instantiate x at any particular value. A credential that says “Joe says x can read foo as long as x satisfies some constraint” does not actually say who is allowed to read foo. There is reason for Joe to give maximum flexibility to downstream credential providers, while also ensuring that, at some point, one of the providers will assign a value to x. In order to ensure that x is eventually ground to some value, Joe may introduce a specific type of conditional fact—called an “instantiation fact” or “inst fact”—into the credential that he issues, along with an additional credential that allows downstream providers to instantiate the variable x. An inst fact grounds x to a value: e.g., inst(x, “AdminBob”), grounds x to the value “AdminBob”, so an assertion like “Marty says inst(x, “AdminBob”)” is Marty's assertion that x is grounded to the value “AdminBob”. Thus, the credentials that Joe issues may look like “Joe says x can read foo, if <the next provider> instantiates x”. (“The next provider” is the next provider to whom the template will be passed—e.g., if Joe is provider 112, then the next provider is provider 116.) Joe may also issue a credential that says, “<the next provider> can say_{∞} inst(x,y)”, thereby delegating to all downstream providers the right to instantiate x at some value. Joe adds these credentials to the “acquired” set of assertions in the template. (It will be recalled that the “can say_{∞}” delegation verb allows the direct recipient of the delegation to re-delegate. So, if Joe says “Marty can say_{∞} blah”, and then Marty says “Fred can say_{∞} blah”, and then Fred says “blah”, Joe will recognize Fred's assertion of “blah” as if Marty had said it.) Since the variable y (in the fact inst(x,y)) now represents the value at which x will be instantiated, y has to satisfy Joe's constraint that the name of that principal begin with “Admin,” so Joe also adds, to the template, the constraint “y matches /Admin.*/”. (In practice, since variable names can be reused, a distinguishing construct called “hash” is used to distinguish different variables from each other, even those that have the same name. So, the inst fact may actually be written as “inst(hash[x],y)”, but for simplicity we omit this point from the present discussion and will re-introduce the use of the hash concept subsequently.) Finally, since Joe responded to the template that he received by including the conditional fact that someone has to instantiate x, the template will be unsatisfied unless some actually does instantiate x. So Joe adds, to the set of assertions to be obtained, the assertion “<the next provider> says inst(x,y)”. Thus, by the time the template is passed to the last provider, either x will have been instantiated to some value that satisfies whatever constraints are in the template, or satisfaction of the template will fail.

Since the variables have to be instantiated by the time the last provider is reached, the n-th credential provider 120 attempts to instantiate any uninstantiated variables (at 124). Instantiation simply means that the last provider makes assertions of the form “<last provider> says inst(x,A)”, where x is some variable that has yet to be instantiated, and A is a specific value to which x is to be ground.

To demonstrate, suppose that the assertion “Joe says x can read foo” is an assertion that, if true, would satisfy some query. Suppose, further, that there are three credential providers—Joe, Marty, and Fred—who will be consulted in that order. Thus, initially template 104 contains set 134 of “to be obtained” assertions, the assertion “Joe says x can read foo,” and that, at this point, there are no acquired assertions or constraints. So, at this point, the template contains the following:

| | |
|---|---|
| Assertions to be obtained: | “Joe says x can read foo” |
| Assertions acquired: | None |
| Constraints: | None |

When this template is passed to Joe, Joe determines (under whatever credential-issuing policy Joe has) that Joe is willing to allow any principal to read foo as long as the principal's username begins with “Admin.” So, Joe issues the following credentials:
“Joe says x can read foo, if inst(x,y)”
“Joe says Marty can say_{∞} inst(x,y)”
   Joe also adds the constraint that y has to match /Admin.*/, and also specifies that the assertion “Marty says inst(x,y)” is to be obtained in order for the template to be satisfied. Thus, at this point, the template contains the following:

| | |
|---|---|
| Assertions to be obtained: | “Marty says inst(x,y)” |
| Assertions acquired: | “Joe says x can read foo, if inst(x,y)” |
| | “Joe says Marty can say∞ inst(x,y)” |
| Constraints: | y matches /Admin.*/ |

Joe now passes this template to Marty, who is the next credential provider in the chain.

Upon receipt of the template, Marty sees that “Marty says inst(x,y)” is an assertion to be obtained. Marty is not the last provider in the chain of providers, so Marty does not make this assertion. But, since Marty received a “can say_{∞}” delegation to make this assertion, Marty can re-delegate the assertion. Since Fred is the next credential provider, Marty replaced the to-be-obtained assertion “Marty says inst(x,y)” with “Fred says inst(x,y)”, and delegates to Fred the right to make this assertion. Marty's actions do not change the constraints, so, at this point, the template contains the following:

| | |
|---|---|
| Assertions to be obtained: | “Fred says inst(x,y)” |
| Assertions acquired: | “Joe says x can read foo, if inst(x,y)” |
| | “Joe says Marty can say∞ inst(x,y)” |
| | “Marty says Fred can say∞ inst(x,y)” |
| Constraints: | y matches /Admin.*/ |

Marty then passes this template to Fred.

Upon receipt of the template, Fred sees that “Fred says inst(x,y)” is an assertion to be obtained, and that “y matches /Admin.*/” is a constraint on the values to which Fred may instantiate x. Fred is the last provider in the chain, so Fred makes an assertion of the form “inst(x,y)” and adds it to the template. There may be many assertions of this form that would satisfy the current state of the template, including all of the template's constraints on x—e.g., “Fred says inst(x, “AdminBob”)”, “Fred says inst(x, “AdminSteve”)”. Since Fred is the last credential provider in the chain, there is no longer a reason to defer the choice of grounding values to later providers, so Fred picks an assertion that satisfies the template (e.g., “Fred says inst(x, “AdminBob”)”), and provides the appropriate credential. At this point, the credentials are:
“Joe says x can read foo, if inst(x,y)”
“Joe says Marty can say_{∞} inst(x,y)”
“Marty says Fred can say_{∞} inst(x,y)”
“Fred says inst(x, “AdminBob”)

In somewhat more formal mathematical detail, the process of satisfying a template may be described as follows. For a given template, it is assumed that there is a set of credential providers, C₁, . . . , C_{N} that will be consulted, in some order, to satisfy a template. It is further assumed that each provider knows the order, at least locally—i.e., provider Cₖ either knows the identity of provider Cₖ₊₁, or knows Cₖ is the last provider in the chain. Thus, there are two different processes that are carried out, one by each of the non-terminal providers C₁, . . . , C_{N-1}, and one by the final provider in the chain, C_{N}.

A template has the form [symbol] a; [symbol] ; [symbol] ; c [symbol] , where α is an atomic statement that represents a query to be satisfied (i.e., the statement that, if true, would cause a guard to grant the requested access), [symbol] is the set of assertions to be obtained, [symbol] is the set of assertions that have already been acquired, and c is a set of constraints. A set of credentials, [symbol] , satisfies [symbol] α; [symbol] ; [symbol] ; c [symbol] if and only if there exists a ground substitution γ such that [symbol] ├γ(αᵢ) for all i=1 . . . N (where the αᵢ are the members of [symbol] , such that [symbol] ={α₁, . . . , α_{N}}), and γ(c) is true.

In describing the processes performed by the credential providers, the following functions are used:
creds_{C}_{ᵢ}( [symbol] c) returns a set of triples [symbol] [symbol] ; θ; c′ [symbol] such that [symbol] [symbol] θ ( [symbol] ) and θ(c) [symbol] c′ is satisfiable. No inst fact (i.e., no fact of the form inst(_,_)) occurs in [symbol] In effect, creds_{C}_{ᵢ} is a function that returns those credentials that a given provider Cᵢ is willing to provide that satisfy a particular set of assertions. Each credential provider Cᵢ has its own version of the creds function (hence the subscript Cᵢ, representing a given provider's instance of the function).
addInst( [symbol] ) is the set of assertions obtained by augmenting each αε [symbol] with a conditional fact inst(hashₓ,x) for each distinct variable x occurring in α. The expression hashₓ stands for a constant that distinguishes each variable x from other variables used in a particular credential-gathering process.
issue( [symbol] ) is a procedure that issues all assertions in [symbol] . I.e., it creates signed credentials corresponding to those assertions (or retrieves existing credentials from a local store), and returns them.
instFacts( [symbol] ) is the set of (concluding or conditional) facts of the form inst(_,_) occurring in [symbol] .
instAssrts( [symbol] ) is the set of assertions in [symbol] whose concluding facts are of the form inst(_,_).

The function creds_{C}_{ᵢ} is specific to each credential provider Cᵢ. Given a constrained set of atomic assertions [symbol] [symbol] , c [symbol] as input, it returns a set of triples [symbol] [symbol] ; 0; c′ [symbol] . Each triple represents a set of credentials that the provider is willing and able to provide and that match a subset of the input specification (including the constraint c). These credentials may be from a local store, or freshly issued and may contain variables that are constrained by c′. They may be more instantiated than the input specification, so the function also returns a substitution 0 that partially maps the input specification onto the output.

The definition of creds_{C}_{ᵢ} is abstract in the sense that each credential provider may decide, in any manner, what credentials it is willing to provide in response to a call to the function. Each Cᵢ may have an issuance policy and/or disclosure policy that governs what credential it is willing to issue, and which of those credentials it is willing to disclose under the circumstances in which the credentials are being requested. This policy may be implemented in any manner—e.g., the policy could be specified in SecPAL, or some other language. creds_{C}_{ᵢ} may return any credentials that satisfy the assertion(s) and constraint(s) provided as input, but typically creds_{C}_{ᵢ} would return the largest, least instantiated, and least constrained assertion sets that satisfy the input and conform Cᵢ's issuance and disclosure policies. Thus, if the input is:

( [symbol] ={Alice says Bob can read f, Bob says Charlie can read f}, c=True)

and Cᵢ is able to make the first assertion in that set, and if Cᵢ's policy allows disclosure of that assertion without further constraints, then Cᵢ will typically disclose that assertion without instantiating f to a more specific value. If the provider returned an assertion with f bound to some concrete value, then the shared variable f in the remaining second assertion would also be bound to the same value, and subsequent credential providers may not be willing or able to provide a credential with that particular value for f. The protocol thus attempts to defer the instantiation of variables until the final credential provider, C_{N}, has been reached.

As noted above, there are two different processes that are carried out by credential providers. One process (referred to herein as “Process-Template-Set”) is carried out by providers other than the last one in the chain, and the other process (referred to herein as “Process-Final-Template-Set”) is carried out by the last provider in the chain. These processes are shown below in Tables 1 and 2.

TABLE 1
Process-Template-Set( [symbol] )

| | |
|---|---|
| 01 | [symbol] := 0; |
| 02 | foreach [symbol] α; [symbol] ; [symbol] ; c [symbol] ∈ [symbol] do |
| 03 | foreach [symbol] [symbol] θ; c′ [symbol] ∈ creds_{C}_{ᵢ} ( [symbol] , c) do |
| 04 | c″ := θ(c) [symbol] c′; |
| 05 | [symbol] := θ( [symbol] )\ [symbol] |
| 06 | [symbol] := instFacts (addInst( [symbol] ) ∪ θ( [symbol] )); |
| 07 | [symbol] := [symbol] \instAssrts (θ( [symbol] )); |
| 08 | [symbol] := [symbol] ∪ { [symbol] Cᵢ₊₁ says : fact [symbol] : fact ∈ [symbol] }; |
| 09 | [symbol] := {Cᵢ says : Cᵢ₊₁ can say_{∞} fact : fact ∈ [symbol] }; |
| 10 | [symbol] := [symbol] ∪ issue(addInst( [symbol] )) ∪ issue( [symbol] ); |
| 11 | [symbol] := T′ ∪ { [symbol] θ(α); [symbol] ; [symbol] ; c″ [symbol] }; |
| 12 | send [symbol] to Cᵢ₊₁; |

TABLE 2
Process-Final-Template-Set( [symbol] )

| | |
|---|---|
| 01 | foreach [symbol] α; [symbol] ; [symbol] ; c [symbol] ∈ [symbol] do |
| 02 | foreach [symbol] [symbol] θ; c′ [symbol] ∈ creds_{C}_{ᵢ} ( [symbol] c) do |
| 03 | c″ := θ(c) [symbol] c′; |
| 04 | [symbol] := θ( [symbol] )\ [symbol] |
| 05 | if [symbol] \instAsserts (θ( [symbol] )) = Ø and ∃γ such that |
| 06 | (γ(c″) is true and γ(α) is an instance of q_{acc}) |
| 07 | then |
| 08 | [symbol] := instFacts (addInst( [symbol] ) ∪ θ( [symbol] )); |
| 09 | [symbol] := {Cᵢ says : γ(fact) : fact ∈ [symbol] }; |
| 10 | [symbol] := [symbol] ∪ issue(addInst( [symbol] )) ∪ issue( [symbol] ); |
| 11 | send [symbol] to U_{acc}; |
| 12 | return; |
| 13 | report failure; |

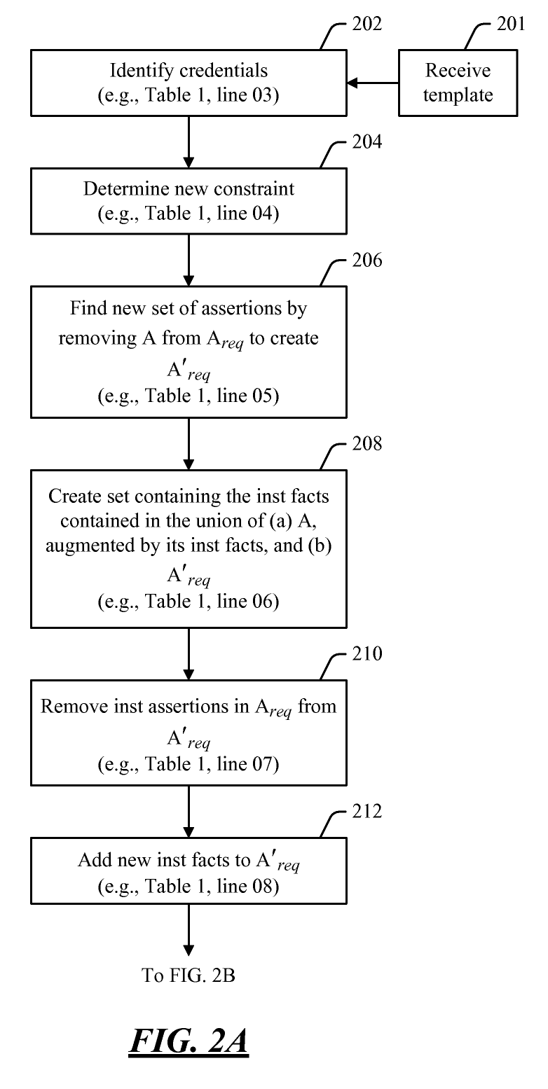

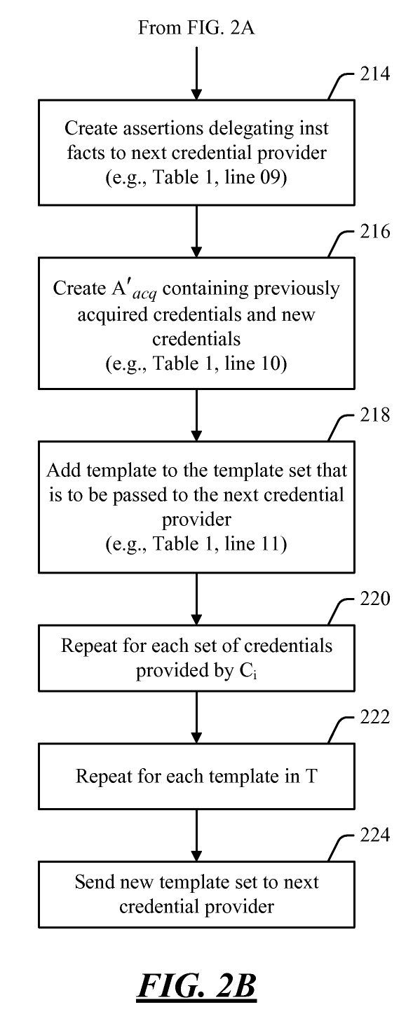

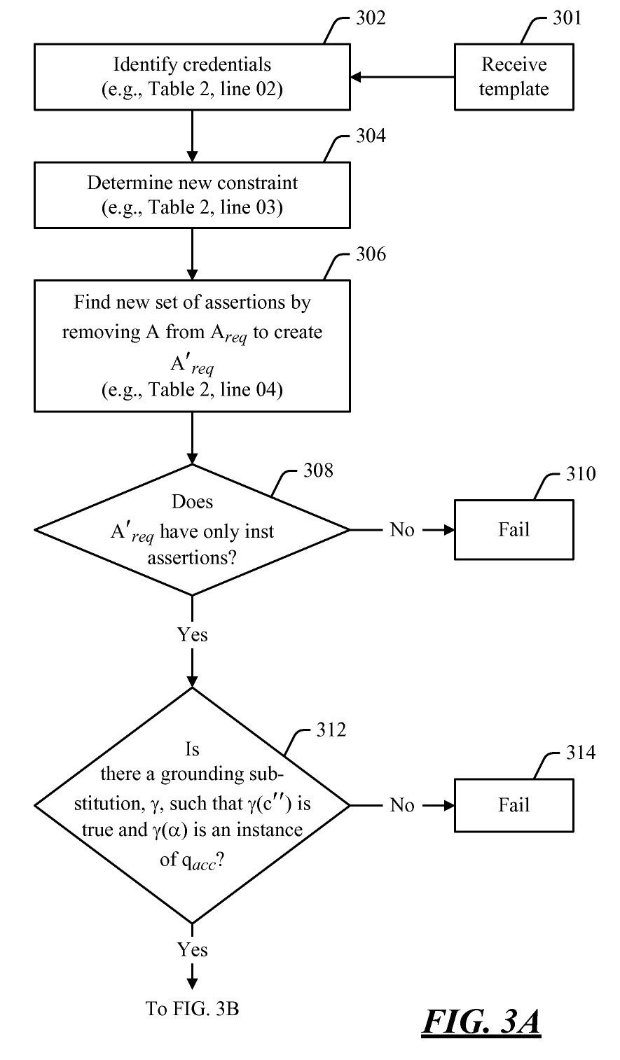

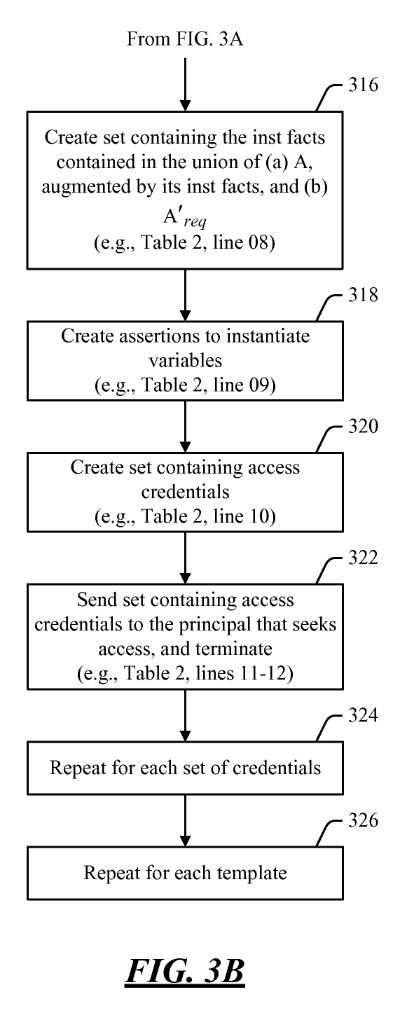

The procedures of Tables 1 and 2 are now described with reference to the flow diagrams of FIGS. 2A-2B and 3A-3B. Before turning to a description of FIGS. 2A-2B and 3A-3B, it is noted that the flow diagrams contained in these figures are described, by way of example, with reference to components shown in FIG. 1, although these processes may be carried out in any system using any components, and are not limited to the scenario shown in FIG. 1. Additionally, each of the flow diagrams in FIGS. 2A-2B and 3A-3B shows an example in which stages of a process are carried out in a particular order, as indicated by the lines connecting the blocks, but the various stages shown in these diagrams can be performed in any order, or in any combination or sub-combination.

FIGS. 2A-2B show, in the form of a flow chart, stages performed by the Process-Template-Set process of Table 1. In Table 1, it is presumed that Process-Template-Set is being carried out by a credential provider referred to as Cᵢ, which receives a set of templates, [symbol] , as its input. For example, if Process-Template-Set is performed by provider 112 (shown in FIG. 1), then provider 112 is provider Cᵢ, and it may receive a set, [symbol] , containing templates 104, 128, and 130 (also shown in FIG. 1) as its input.

The output of Process-Template-Set is another template set, which is to be passed to another provider (e.g., template 114, which provider 112 sends to provider 116, as shown in FIG. 1). Thus, Process-Template-Set starts by initializing a new set of templates, [symbol] , which acts as an accumulator for the new templates to be sent to the next credential provider in the path. [symbol] is the template set that will eventually be passed to the next provider, Cᵢ₊₁.

For each template [symbol] α; [symbol] ; [symbol] ; c [symbol] in template set [symbol] , Process-Template-Set receives the template (at 201) and performs the actions shown in the flow chart of FIGS. 2A-2B. At 202, the process uses the creds_{C}_{ᵢ} function to identify the credentials that provider Cᵢ is willing to provide toward satisfying a particular template (Table 1, line 03). creds_{C}_{ᵢ} returns a set of triples, [symbol] [symbol] ; θ; c′ [symbol] , where [symbol] is the set of assertions that Cᵢ is willing to make, θ is a substitution that maps variables between [symbol] and [symbol] , and c′ is a set of constraints that Cᵢ imposes on variables in the assertions that it provides. For each of these triples, Process-Template-Set may perform the actions shown in lines 04 through 11 of Table 1.

At 204, a new constraint, c″, is determined (Table 1, line 04). The new constraint is the conjunction of the original constraint c (renamed by θ), and c′.

Next, the process begins to construct a new set of to-be-obtained assertions (A′_{req}), which will eventually be part of a new template to be passed to the next credential provider. At 206, any assertions provided by Cᵢ (i.e., assertions [symbol] ) that also appear in [symbol] (as renamed by θ) are removed from [symbol] (Table 1, line 05). Since Cᵢ is willing to provide assertions [symbol] , they are no longer in the “to-be-obtained” category, and may be removed from

[symbol]

At 208, a set [symbol] is created (Table 1, line 06), which contains the inst facts (i.e., facts of the form inst(_,_) which appear in either [symbol] (as augmented by inst fact to instantiate any uninstantiated variables in [symbol] ), or in [symbol] (as renamed by θ). It will be recalled that the addInst( [symbol] ) function adds, to each assertion αε [symbol] , a conditional fact of the form inst(hashₓ,x) for each distinct variable x that occurs in α, and instFacts(A) extracts those facts of the form inst(_,_) from [symbol] . Thus, [symbol] contains an inst fact for each variable that has yet to be instantiated in either the assertions [symbol] that Cᵢ provided, or in [symbol] (as renamed by θ), and thus may be calculated as [symbol] :=instFacts (addInst( [symbol] ) ∪ θ( [symbol] )).

At 210, the set [symbol] , (which was initially constructed at 206) is modified by removing assertions of the form Cᵢ says inst(hashₓ,x). As will be recalled, instAssrts( [symbol] ) returns such assertions from the set [symbol] , so the modification may be performed by calculating [symbol] = [symbol] \instAssrts (θ( [symbol] )), (See Table 1, line 07.)

At 212, [symbol] is augmented by adding to it assertions of the form (Cᵢ₊₁ says fact), for those facts that are in [symbol] . It will be recalled that, if Cᵢ is performing Process-Template-Set, then Cᵢ is not the terminal provider in the chain (since that provider will perform Process-Final-Template-Set). Since instantiation of variables is typically delayed until the last provider is consulted, Cᵢ will not be instantiating the variables, so facts of the form Cᵢ says inst(hashₓ,x) were removed from [symbol] at 210. Instead, for any uninstantiated variables—either those contained in assertions inherited from [symbol] , or those contained in new assertions in [symbol] provided by Cᵢ—assertions of the form [symbol] Cᵢ₊₁ says fact [symbol] are added to [symbol] . It will be recalled that [symbol] was constructed to contain inst facts for those variables, so the calculation may be performed as indicated in Table 1, line 08.

At 214, a set of assertions is created that delegates, to the next provider, the right to assert the inst facts contained in [symbol] . That is, for each fact contained in [symbol] , an assertion of the form “Cᵢ says Cᵢ₊₁ can say_{∞} fact” is created, as indicated by Table 1, line 09. Since these delegations are made with “can say_{∞}”, Cᵢ₊₁ can re-delegate the instantiation, thereby allowing instantiation to be deferred until the last provider is reached. The assertions are collected in the set labeled

[symbol]

At 216, a set of acquired assertions, [symbol] , is created to include in the new template, as indicated in Table 1, line 10. This set of assertions comprises the credentials that have already been acquired ( [symbol] ), plus the assertions [symbol] that have been provided by Cᵢ (augmented with conditional inst facts for their uninstantiated variables), plus the assertions [symbol] that delegate instantiation of variable to Cᵢ₊₁.

The new template that results from the calculations performed at 204-216 (or by lines 04 through 10 of Table 1) may be described as [symbol] θ(α); [symbol] ; [symbol] ; c″ [symbol] . At 218, this template is added to the template set [symbol] (see Table 1, line 11). It will be recalled that [symbol] was was initialized at line 01 of Table 1 in order to accumulate the templates created by Process-Template-Set.

As indicated by the nested “foreach” statements in Table 1, lines 04-11 of Table 1 (or the blocks of FIGS. 2A-2B corresponding thereto) may be repeated (at 220) once for each set of credentials returned by creds_{C}_{ᵢ} so Process-Template-Set adds a new template to [symbol] for each set of credentials that Cᵢ provides. Moreover, lines 03-11 of Table 1 (or the blocks of FIGS. 2A-2B corresponding thereto) may be repeated once for each template in [symbol] (at 222), so the process of calling creds_{C}_{ᵢ} and generating one or more templates in response to the returned credentials is performed once for each template in the input set [symbol] .

After [symbol] has been constructed, it is sent to the next credential provider, Cᵢ₊₁ (at 224).

FIGS. 3A-3B show, in the form of a flow chart, stages performed by the Process-Final-Template-Set process of Table 2. This process may be performed by the terminal provider in a chain of credential providers.

Process-Final-Template-Set receives a set of templates, [symbol] , as its input. For each template received (at 301), Process-Final-Template-Set starts by attempting to satisfy any remaining assertions in the [symbol] sets of the template. Thus, the process (at Table 2, lines 02-04) identifies credentials using creds_{C}_{ᵢ} (at 302), calculates the new constraints (at 304), and generates the set [symbol] (at 306), in much the same manner as is done in Process-Template-Set (FIG. 2A, at 202-206).

At this point, all credential providers have been consulted to obtain whatever substantive credentials (i.e., credentials asserting facts other than inst fact) they are able to provide. Thus, if the template is satisfiable, the only thing left to do is instantiate variables. So, a satisfiable [symbol] set, at this point in the credential-gathering process, contains only assertions whose concluding facts are inst facts. If such is the case (as determined at 308, and by Table 2, line 05), then the process continues. Otherwise, the attempt to satisfy the current template in [symbol] with the current set of credentials returned by creds_{C}_{ᵢ}, fails (at 310).

If the process has not yet failed, then certain determinations are made at 312 (see Table 2, lines 05-06). In particular, it is determined whether there is a grounding substitution y, such that the final set of constraints, c″ is true when variables have been substituted according to γ. Additionally, it is determined whether the atomic assertion α (with substitutions performed according to γ) is an instance of the query (which has been labeled as q_{acc}) that will be submitted to a resource guard in order to gain access to a resource. (α represents the statement that would be proved true by the credentials that have been gathered from all of the credential providers.) If either of the conditions determined at 312 is not true, then the attempt to satisfy the current template in [symbol] , using the current set of credentials returned by creds_{C}_{ᵢ}, fails (at 314). Otherwise, the process continues as described below.

At 316 (see Table 2, line 08), fact set [symbol] is created in the same manner as in FIG. 2A at 208 (Table 1, line 06). Since the current provider is the last one in the chain, it is up to the current provider to instantiate any uninstantiated variables that remain. So, a set [symbol] is created (at 318), which asserts the inst facts that instantiate the remaining variables. Unlike the [symbol] set that was created in Process-Template-Set which merely delegated to the next provider the right to assert the appropriate inst facts, the [symbol] set that is generated in Process-Final-Template-Set contains actual assertions of these inst facts, made by the terminal credential provider Cᵢ. The values assigned to any variables in the facts are made according to the grounding substitution γ (as indicated by the expression y(fact) in Table 2, line 09). γ is ground in the sense that it binds each variable to a specific value (as opposed to substitutions that have been labeled θ, which might bind a variable to a specific value, but also might merely bind one variable to another). The particular values that γ assigns to variables satisfy the condition shown in line 06 of Table 2, so the final constraint set is satisfied by substitution, and the substitution also allows the credentials to prove an instance of the query that will be submitted to the resource guard.

At 320, a set [symbol] is created, which contains the credentials that may be presented to the resource guard to satisfy the access query (see Table 2, line 10). [symbol] contains the assertions [symbol] that have been acquired from other providers, plus the assertions [symbol] provided by the current provider (as augmented by their conditional inst facts), plus the current provider's assertion of inst facts to instantiate all of the uninstantiated variables. At 322, [symbol] is sent to the principal (labeled U_{acc}), who will seek access to a resource from the resource guard (Table 2, line 11), and the process terminates (Table 2, line 12).

If the process has not been terminated, then the process may be repeated (at 324) for each set of credentials returned by creds_{C}_{ᵢ} and (at 326) for each template in [symbol] . The nesting of foreach loops in Table 2 shows how the various actions are repeated for different sets of credentials and different templates. Repetition continues until the process either terminates by sending a set [symbol] to U_{acc}, or reports failure (at Table 2, line 13).

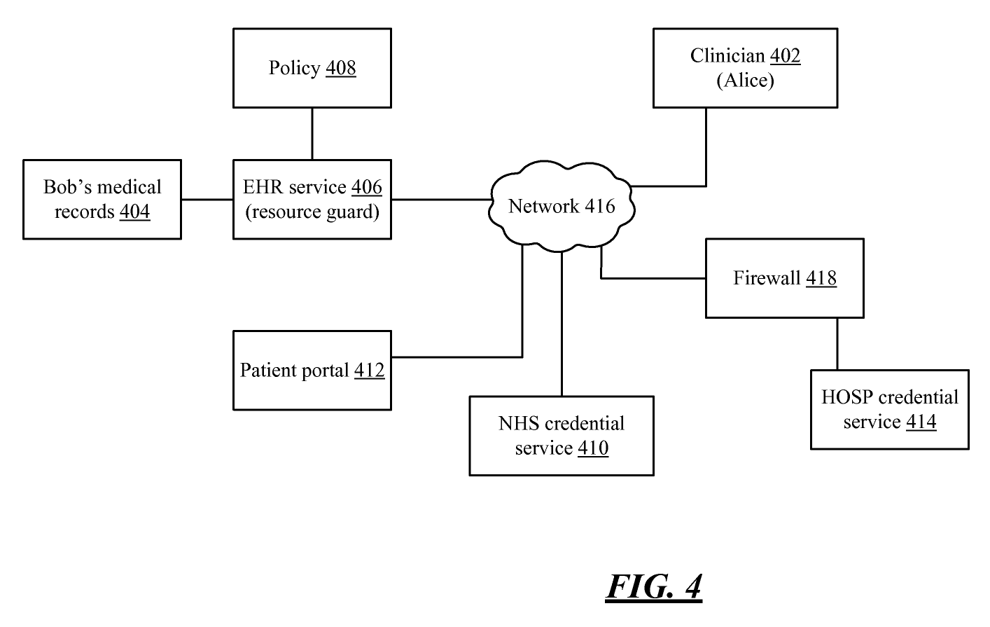

An example medical records scenario is now described with reference to FIG. 4.

In this scenario, clinician Alice (at 402) wishes to access patient Bob's medical records (at 404) on the Electronic Health Records (EHR) server (at 406). In the vocabulary of the prior discussion, EHR is a resource guard, and Bob's medical records are a resource to which access is gated by the guard. Medical records may relate a description of a patient's human body and/or treatment thereof, and thus may constitute sensitive information. Therefore, EHR does not disclose these records unless proper credentials have been presented. In order to make sure that she will possess the credentials when she requests access, Alice initiates the credential gathering protocol at some point prior to requesting access.

The EHR service's policy 408 states that access to a patient y's medical records is granted to a principal x if x is a clinician, x is treating y, and y has given consent to this access. The policy also calls for the validity time span of the consent to be contained in the time span of the clinical relationship. EHR's policy 408 may be expressed as follows:

EHR says: x can access y's medical records if
x is a clinician,
x is treating y (from t₁ until t₂);),
x has y's consent (from t₃ until t₄),
where t₁≦t₃≦t₄≦t₂

EHR delegates authority over role membership definitions (expressed by facts of the form e₁ is an e₂) to the National Health Service (NHS) (at 410). Thus if the NHS says that a principal is a clinician or a hospital, EHR will say it as well. As clinical relationships (expressed by “e₁ is treating e₂ (from e₃ until e₄)”) are not managed centrally, EHR also delegates this task to individual hospitals. Similarly, patient consent (expressed by “e₂ has e₁'s consent (from e₃ until e₄)”) is not managed by the EHR either, but by a separate patient health portal (PP) (at 412), at which patients can, among other actions, register their consent for other people to access their sensitive data. EHR therefore delegates authority over consent facts to PP but imposes the condition that the validity time span be at most one year. These aspects of EHR's policy may be expressed as follows:

EHR says: NHS can say₀ x is a r

EHR says: x can say₀ y is treating z (from t₁ until t₂) if
x is a hospital,
y is a clinician.

EHR says: PP can say₀ y has x's consent (from t₁ until t₂)
where t₂−t₁≦365 days
   It is noted that two of the assertions in the example policy above use the variables named t₁ and t₂, but these are different instances of variables that happen to have the same name, and may be assigned values independently of each other.

Alice begins the process of obtaining credentials by initiating an abductive query on the EHR service. In order to access Bob's medical records, Alice would like the statement “HER says Alice can access Bob's medical records” to be true, so Alice submits the abductive query

q=EHR says: Alice can access Bob's medical records

together with her NHS-issued clinician credential <NHS says: Alice is a clinician>. The answer is a template set containing one template (q; A_{req}; A_{acq}; c), where A_{acq}=<NHS says: Alice is a clinician> (i.e., the credential that Alice provided at the outset to the abduction process as a “supporting credential”), and A_{req} comprises the assertions:

NHS says: x is a hospital

x says: Alice is treating Bob (from u₁ until u₂)

PP says: Alice has Bob's consent (from u₃ until u₄)

The constraint c is equal to u₁≦u₃≦u₄≦u₂ [symbol] u₄−u₃≦365 days.

Since the template set returned by the abduction process is not empty (which would have meant that the access sought is not supported no matter which additional credentials were provided), and the missing-credential specification A_{req} is not empty (which would have meant that Alice already possesses all the requisite credentials to support access), the protocol proceeds by gathering credentials matching A_{req} and the constraint c.

The various parties who will participate in the credential-gathering process are connected by network 416. Thus communication among these parties is possible, although there may be limitations on who can communicate with whom, and under what circumstances. For example, HOSP may be behind firewall 418, which prevents direct interaction between HOSP and entities outside the hospital's local network. It is noted that the credential gathering process described herein may be used even when direct, on-demand interaction with some of the providers is not available, and even if some of the providers are not able to communicate with other providers. In general, the credential gathering process may work in any situation where there is a linear path by which all providers eventually can be consulted, which includes a very wide variety of connectivity scenarios.

In order to attempt to gather the credentials, Alice forwards the returned template set to the first credential provider, C₁, which, in this example, is the hospital's credential-providing service 414 (labeled HOSP). HOSP receives the template set (containing the one template described above) as input, and performs Process-Template-Set on the input. The hospital's credential disclosure policy allows the disclosure of the locally stored NHS-issued credential stating that HOSP is a hospital. Furthermore, since Alice has started treating Bob on the date Oct. 7, 2008, with the therapy lasting six months, creds_{HOSP} returns a triple [symbol] [symbol] ; θ; c′ [symbol] , where [symbol] is the set:

| | |
|---|---|
| { | NHS says : HOSP is a hospital; |
| | HOSP says : Alice is treating Bob (from ν₁ until ν₂) }, |

Note that HOSP is not limited to providing assertions that HOSP makes itself, so in this example the first assertion provided by HOSP is actually a credential issued by NHS. θ is the substitution [u₁ [symbol] v₁, u₂ [symbol] v₂], and c′ is the constraint Oct. 7, 2008≦v₁≦v₂≦Apr. 6, 2009. This gives rise to a new template set [symbol] containing a single template [symbol] q; [symbol] ; [symbol] ; c′ [symbol] . The new set of acquired credentials [symbol] contains [symbol] unioned with

NHS says: HOSP is a hospital

HOSP says: Alice is treating Bob (from v₁ until v₂) if
inst(hashᵥ_{₁}, v₁),
inst(hashᵥ_{₂}, v₂)

HOSP says: PP can say_{∞} inst(hashᵥ_{₁}, v₁)

HOSP says: PP can say_{∞} inst(hashᵥ_{₂}, v₂)

And the set of assertions yet to be acquired (i.e., the assertions in [symbol] contains

PP says: Alice has Bob's consent (from u₃ until u₄)

PP says: inst(hashᵥ_{₁}, v₁)

PP says: inst(hashᵥ_{₂}, v₂)

(In this example, HOSP knows that PP is the next provider in the chain, so when HOSP adds inst facts, it identifies PP as the provider that will assert the inst facts.) The new constraint c″ is equal to θ (c) [symbol] c′, hence

c″ v₁≦u₃≦u₄≦v₂ [symbol] u₄−u₃≦365 days
[symbol] Oct. 7, 2008≦v₁≦v₂≦Apr. 6, 2009

The new template set is sent to PP, which, being the last credential provider in the path, executes Process-Final-Template-Set. Assuming that Bob has given consent for Alice to access his sensitive data without specifying restrictions on the time span, creds_{PP} returns a triple [symbol] [symbol] ; θ; c′ [symbol] containing:

[symbol] ={PP says: Alice has Bob's consent (from w₁ until W₂)},

θ=the substitution [u₃ [symbol] w₁; u₄ [symbol] w₂],and c′=True.

(The truth value of “true [symbol] exp” is equal to exp. The constraints that are accumulated through the credential-gathering process are conjoined with an “and” ( [symbol] ) operator, so, by returning “true” as a constraint, creds_{PP} is simply saying that it is not adding any additional constraints to the accumulating set of constraints.)

In the case where Bob has not yet given consent, the execution of creds_{PP} may involve sending a notification to Bob and waiting for him to give or deny consent. It is noted that credential gathering that involves waiting for action by a person is difficult to achieve in a centralized, on-demand credential gathering process, but can be carried out relatively easily using the techniques described herein. Having found a credential to satisfy the only assertion in [symbol] that does not involve an inst fact, Process-Final-Template-Set proceeds by attempting to find a ground variable assignment, y, that satisfies the constraint. There may be various assignments y, and the credential provider that executes Process-Final-Template-Set can choose any one, and can make the choice using any technique. One example solution to γ in this example gives rise to the final set of acquired credentials [symbol] , which contains [symbol] unioned with:

PP says: Alice has Bob's consent (from Oct. 7, 2008 until Nov. 6, 2008)

PP says: inst(hashᵥ_{₁}, Oct. 7, 2008)

PP says: inst(hashᵥ_{₂}, Nov. 6, 2008)

These credentials are sent back to Alice who can eventually present them to the resource guard EHR to support her access query for Bob's medical records.

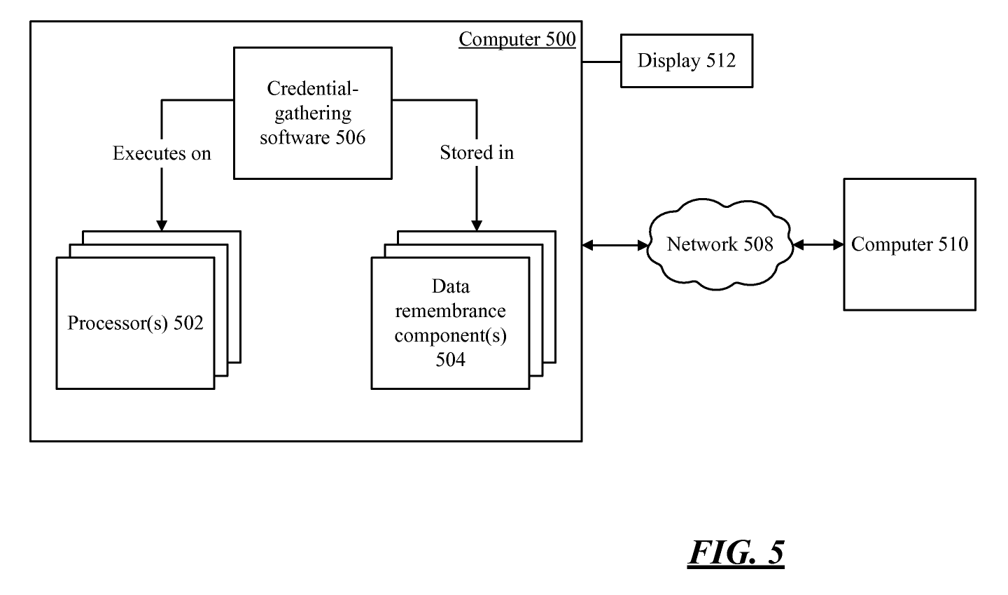

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is credential-gathering software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions that, when executed by a computer, cause the computer to perform acts to facilitate obtaining access to a resource, the acts comprising:
identifying a first set of assertions that a first provider will make, said first set of assertions including at least a first assertion, said first assertion comprising a variable, said first assertion, when made to a guard of the resource, supporting access to the resource;
generating a second assertion that asserts a first fact asserted in said first assertion and that imposes, as a condition on asserting said first fact, that a second provider, or said second provider's delegate, instantiate said variable;
generating a third assertion that delegates, to said second provider, a right to instantiate said variable;
creating a first template that comprises said second assertion and said third assertion; and
sending said first template to said second provider.

2. The one or more computer-readable storage media of claim 1, further comprising:
receiving a second template that identifies a second set of assertions that are to be obtained to support access to the resource.

3. The one or more computer-readable storage media of claim 2, wherein said identifying comprises:
finding existing credentials that satisfy said one or more assertions.

4. The one or more computer-readable storage media of claim 2, wherein said identifying comprises:
consulting a policy to determine which new assertions can be made to satisfy said one or more assertions.

5. The one or more computer-readable storage media of claim 2, wherein said second template is generated by abducting said one or more assertions from a query that requests access to the resource.

6. The one or more computer-readable storage media of claim 1, further comprising:
imposing a constraint on said variable; and
including said constraint in said first template.

7. The one or more computer-readable storage media of claim 1, wherein the resource comprises a physical resource, and wherein the guard physically gates access to the resource.

8. The one or more computer-readable storage media of claim 1, wherein said first provider and second provider are physically separate components that are communicatively connected by a network, and wherein said first provider sends said first template to said second provider after said creating act.

9. The one or more computer-readable storage media of claim 1, wherein said variable is instantiated by asserting an instantiation fact on said variable, and wherein said condition is imposed on said first fact by including as a conditional fact, in said second assertion, a second fact that comprises said instantiation fact.

10. A system to obtain credentials to gain access to a resource, the system comprising:
a first credential provider that receives a template that describes a set of assertions that, when presented to a guard of the resource, cause the guard to grant access to the resource, said first credential provider identifying a first assertion that said first credential provider is willing to provide that that satisfies a second assertion contained in said set of assertions, said first assertion comprising a variable, said first credential provider creating a third assertion that comprises said first assertion with instantiation of said variable as a conditional fact, said first credential provider further creating a fourth assertion that delegates to a second credential provider a right to instantiate said variable, said first credential provider being communicatively connected to said second credential provider through a network, said first credential provider sending, to said second credential provider, a template comprising said third assertion and said fourth assertion.

11. The system of claim 10, wherein said second credential provider receives said template from said first credential provider and creates a fifth assertion that instantiates said variable.

12. The system of claim 10, wherein said second credential provider receives said template from said first credential provider and creates a fifth assertion that delegates, to a third credential provider, a right to instantiate said variable.

13. The system of claim 10, wherein further comprising:
an abducer that generates said set of assertions from a query that requests access to the resource, and from a policy that the guard uses to determine whether access requested by the query is allowed.

14. The system of claim 10, wherein the resource comprises a medical record that describes a human body of a patient or a treatment of said human body.

15. The system of claim 10, wherein said first credential provider provides a constraint on said variable, and wherein said second credential provider instantiates said variable to a value that satisfies said constraint.

16. A method of allowing access to a resource, the method comprising using a processor to perform acts comprising:
receiving, from a first credential provider at a second credential provider, a template that comprises a first set of assertions to be made to support access to the resource, said first set of assertions comprising a first assertion that asserts instantiation of a variable and a second assertion in which said first credential provider delegates to said second credential provider a right to instantiate said variable, said template further comprising a first constraint on said variable;
finding a ground substitution that assigns a value to said variable that satisfies said first constraint;
providing a third assertion that asserts an instantiation fact to instantiate said variable at said value;
issuing a credential that comprises said third assertion; and
providing said credential to a guard of said resource.

17. The method of claim 16, further comprising:
gaining access to said resource from said resource guard.

18. The method of claim 16, wherein said resource comprises a physical resource, and wherein said guard takes a tangible action to allow access to said physical resource.

19. The method of claim 16, further comprising:
abducting, from a policy under which a guard gates access to the resource and from a query that requests access to the resource, a second set of assertions that, if presented to the guard, cause the guard to grant access to the resource.

20. The method of claim 16, wherein said second credential provider imposes a second constraint on said variable, and wherein the method further comprises:
conjoining said first constraint with said second constraint to generate a conjoined constraint,
wherein said ground substitution satisfies said first constraint by satisfying said conjoined constraint.
